(19) United States
(12) Patent Application Publication
(10) Pub. No.: US 2023/0197094 A1
(43) Pub. Date: Jun. 22, 2023

(54) ELECTRONIC DEVICE AND METHOD FOR OBTAINING A USER'S SPEECH IN A FIRST SOUND SIGNAL

(71) Applicant: GN Hearing A/S, Ballerup (DK)

(72) Inventors: Charlotte SØRENSEN, Tjele (DK); Jesper BÜNSOW BOLDT, Måløv (DK)

(73) Assignee: GN Hearing A/S, Ballerup (DK)

(21) Appl. No.: 17/959,184

(22) Filed: Oct. 3, 2022

(30) Foreign Application Priority Data
Dec. 16, 2021 (DK) PA 2021 70627
Jan. 5, 2022 (EP) EP 22150316.2

(51) Int. Cl. G10L 21/0216; G10L 25/90; G10L 21/028

(52) U.S. Cl. CPC G10L 21/0216; G10L 25/90; G10L 21/028; G10L 2021/02166

(57) ABSTRACT

An electronic device includes: a first external input transducer configured to capture a first sound signal that comprises a first speech part of a speech of a user and a first noise part of noise from a surrounding; an internal input transducer configured to capture a second signal, the second signal comprising a second speech part of the speech of the user, where the first speech part and the second speech part are of a same speech portion of the speech at a first time interval; and a signal processor configured to: estimate a fundamental frequency of the speech of the user at the first time interval based on the second signal; update the first model based on the estimated fundamental frequency of the speech at the first time interval; and process the first sound signal based on the updated first model to obtain the first speech part.

### RELATED APPLICATION DATA

This application claims priority to Danish Patent Application No. PA 2021 70627 filed on Dec. 16, 2021, and European Patent Application No. EP 22150316.2 filed on Jan. 5, 2022. The entire disclosures of the above applications are expressly incorporated by reference herein.

### FIELD

The present disclosure relates to an electronic device and a method in an electronic device, for obtaining a user's speech in a first sound signal. The first sound signal comprising the user's speech and noise from the surroundings. The electronic device comprises a first external input transducer configured for capturing the first sound signal. The first sound signal comprising a first speech part of the user's speech and a first noise part.

### BACKGROUND

In a hearing device, an external microphone may be arranged on the hearing device for capturing sounds from the surroundings. When the user of the hearing device speaks, the external microphone of the hearing device may capture both the user's speech and sounds from the surroundings. If the user of the hearing device is having a phone call with a far-end caller, the user's speech may be captured by the external microphone of the hearing device and transmitted to the far-end caller. However, as the external microphone may capture both the user's speech and sounds from the surroundings, the sounds from the surroundings may be perceived as noise in a phone call, where it is desired to only transmit the user's speech and not the sound/noise from the surroundings.

Thus, there is a need for an improved method and electronic device for obtaining, from a sound signal, a user's speech or own-voice with no noise, limited noise or only little noise in the signal.

### SUMMARY

Disclosed is a method in an electronic device, for obtaining a user's speech in a first sound signal. The first sound signal comprising the user's speech and noise from the surroundings. The electronic device comprises a first external input transducer configured for capturing the first sound signal. The first sound signal comprising a first speech part of the user's speech and a first noise part. The electronic device comprises an internal input transducer configured for capturing a second signal. The second signal comprising a second speech part of the user's speech. The first speech part and the second speech part are of a same speech portion of the user's speech at a first interval in time. The electronic device comprises a signal processor. The signal processor may be configured for processing the first sound signal and the second signal. The method comprises, in the signal processor, estimating a first fundamental frequency of the user's speech at the first interval in time. The first fundamental frequency being estimated based on the second signal. The method comprises, in the signal processor, applying the estimated first fundamental frequency of the user's speech at the first interval in time into a first model to update the first model. The method comprises, in the signal processor, processing the first sound signal based on the updated first model to obtain the first speech part of the first sound signal.

According to an aspect, disclosed is an electronic device for obtaining a user's speech in a first sound signal. The first sound signal comprising the user's speech and noise from the surroundings. The electronic device comprises a first external input transducer configured for capturing the first sound signal. The first sound signal comprising a first speech part of the user's speech and a first noise part. The electronic device comprises an internal input transducer configured for capturing a second signal. The second signal comprising a second speech part of the user's speech. Where the first speech part and the second speech part are of a same speech portion of the user's speech at a first interval in time. The electronic device comprises a signal processor. The signal processor may be configured for processing the first sound signal and the second signal. Where the signal processor is configured to:

estimating a fundamental frequency of the user's speech at the first interval in time, the fundamental frequency being estimated based on the second signal;

applying the estimated fundamental frequency of the user's speech at the first interval in time into a first model to update the first model;

processing the first sound signal based on the updated first model to obtain the first speech part of the first sound signal.

The method and electronic device provides the advantage of obtaining, from a sound signal, the user's speech or own-voice with no noise, limited noise or only little noise.

When a user of an electronic device speaks, a first sound signal can be captured by a first external input transducer, such as a microphone pointing towards the surroundings, and the first sound signal may comprise both speech of the user and noise from the surroundings. At the same time, a second signal can be captured by an internal input transducer, such as a vibration sensor arranged in the ear canal of the user, and the second signal may comprise only the speech of the user, as there is no noise or only limited noise from surroundings captured in the ear canal of the user.

Based on the second signal, a first fundamental frequency of the user's speech can be estimated, and this estimated first fundamental frequency can be applied in a first model. The first sound signal can then be processed based on the first model, and thereby the user's speech as captured by first external input transducer can be obtained without noise, or with only little noise, from the surroundings.

Thus, it is an advantage that in order to obtain the user's speech signal without background noise, the own-voice signal is obtained by combining an internal input transducer, such as an in-ear bone conduction microphone, i.e. vibration sensor, with a processed signal from one or more external input transducers, e.g. a microphones, in the electronic device, such as a hearing device or ear phones. The processing of the signal(s) from the external input transducer(s) may be done with a harmonic filter if only one external input transducer is present. If two external input transducers are present, the processing may be done with a harmonic beamformer.

When a person speaks, the voice does not only propagate through the air but also propagates through vibration of the jaw and ear canal, which can be picked up by an internal input transducer, such as an in-ear vibration sensor. The internal input transducer may alternatively be a microphone in the ear pointed towards the ear canal. The internal input transducer can pick up the user's own voice without the external background noise.

However, the bandwidth of the internal input transducer, such as a vibration sensor, may be limited to the low frequencies, such as maximum up to approximately 1.5 kHz, and, thus, the internal input transducer may not capture the entire speech spectrum. On the other hand, harmonic modelling, filtering and beamforming techniques can outperform traditional methods by using information about the frequency content of the user's own voice signal to reduce noise. The information being used are the fundamental frequency, also called pitch, and multiples of the fundamental frequency, called the harmonics. Harmonic filtering and beamforming use the harmonic structure of the speech signal to separate the speech from noise. However, the harmonic filtering and beamforming approach requires a reliable estimate of the fundamental frequency, i.e., pitch, to construct the harmonic filter which is difficult to obtain if the speech signal is highly corrupted by noise.

By using these two techniques, the fundamental frequency can be estimated from the relatively clean internal input transducer signal, e.g. vibration sensor signal, since the fundamental frequency is in the range of 100-400 Hz for normal speech and be used to construct a harmonic beamformer or filter tuned to pick up the voiced segments of the user's own voice.

The fundamental frequency can both be estimated unilateral, i.e. using one hearing device, but also bilateral, i.e. using two hearing devices, one in the left ear and one in the right ear, by using a multi-channel fundamental frequency estimator to achieve a better fundamental frequency estimate by taking advantage of the fact that the own-voice signal should be equally present at the internal input transducers, e.g. vibration sensors, in both ears. This fundamental frequency estimator could also use the external input transducer, e.g. microphone, signals to improve the estimate, if the external signals are less noisy in specific frequency regions.

The fundamental frequency is defined as the lowest frequency of a periodic waveform. In music, the fundamental is the musical pitch of a note that is perceived as the lowest partial present. In terms of a superposition of sinusoids, the fundamental frequency is the lowest frequency sinusoidal in the sum of harmonically related frequencies, or the frequency of the difference between adjacent frequencies. The fundamental frequency is usually abbreviated as f0 or ω0, indicating the lowest frequency counting from zero.

The obtained first speech part of the first sound signal may be used for various purposes.

One example is to use the obtained first speech part for voice control of the electronic device, such as accepting incoming phone calls on the electronic device, changing modes of the electronic device etc.

Another example is to use the obtained first speech part in a phone call between the user of the electronic device and a far-end recipient. In the electronic device, the first external input transducer may be arranged on the electronic device for capturing sounds from the surroundings. When the user of the electronic device speaks, the first external input transducer of the electronic device may capture both the user's speech and sounds from the surroundings. If the user of the electronic device is having a phone call with a far-end caller, the user's speech may be captured by the external input transducer of the electronic device and transmitted to the far-end caller. However, as the external input transducer may capture both the user's speech and sounds from the surroundings, the sounds from the surroundings may be perceived as noise in a phone call, where it is desired to only transmit the user's speech and not the sound/noise from the surroundings.

Therefore, it is an advantage of the method and electronic device that the user's speech or own-voice is obtained from the first sound signal, with no noise, limited noise or only little noise in the signal.

The method may further comprise transmitting the first speech part to a far-end recipient, whereby the far-end recipient receives the first speech signal and not the noise signal of the first sound signal. Thereby will the far-end recipient receive a clean speech signal and no noise, limited noise or only little noise from the surroundings of the user.

The electronic device may therefore comprise a transceiver and an antenna for transmitting the signal, e.g. the first speech part of the first sound signal, processed in the signal processor, to another device, such as a smart phone paired with the electronic device. Phone calls with far-end callers may be performed using the smart phone, whereby the first speech part of the first sound signal may be transmitted via the wireless connection in the phone call to a transceiver of a second electronic device, such as a smart phone of the far-end caller.

Improving the signal received by the far-end caller on the quiet end of a telephone conversation can help ease the communication for both parties. The user of the electronic device may be the person located in a noisy background. The user can increase the signal-to-noise ratio (SNR) by turning up the volume of the phone. However in prior art, this is not the case for the far-end caller on the quiet receiving end where the signal is mixed with background noise.

Therefore, it is an advantage to improve the signal obtained at the noisy end of the telephone line before sending it to the far-end caller as this helps the far-end caller to be able to understand what is being said as well as it decreases frustration for the user due to not being understood or having to repeat him-/herself.

A third example is to use the obtained first speech part in health examinations, as speech may be used to detect diseases, such as dementia, Parkinson's disease etc.

The method is performed in an electronic device. The method may be performed by the electronic device. The electronic device may be a hearing device, a hearing aid, a headset, hearables, an ear device, ear phones or a body-worn device. The external input transducer may be arranged in a hearing device. The internal input transducer may be arranged in the same hearing device as the external input transducer, or alternatively the internal input transducer may be arranged in another device, such as a body-worn device. Thus, the internal input transducer may be arranged on the user's body instead of in the ear for obtaining the user's speech in a first sound signal.

The method is for obtaining a user's speech in a first sound signal. The first sound signal comprises the user's speech and noise from the surroundings.

The electronic device comprises a first external input transducer configured for capturing the first sound signal. The first external input transducer may be arranged or pointing outwards from the user. The first external input transducer may be a microphone pointing towards the surroundings. The first external input transducer may be an external microphone on an earpiece of a hearing device. The first external input transducer may be an exterior input transducer, an outer input transducer, an outward input transducer etc.

The first sound signal comprises a first speech part of the user's speech and a first noise part.

The electronic device comprises an internal input transducer configured for capturing a second signal. The internal input transducer may be arranged or pointing inwards on user's body. The internal input transducer may be a vibration sensor in the user's ear canal. The internal input transducer may be a microphone in the ear canal. The internal input transducer may be a sensor another place on the user's body, e.g. on the user's wrist etc. The internal input transducer may be an interior input transducer, an inner input transducer, an inward input transducer etc.

The second signal may be a vibration signal. Alternatively, the second signal may be a sound signal. The first sound signal is a sound signal.

The second signal comprises a second speech part of the user's speech. The second signal comprises substantially no noise part or only limited noise or only little noise.

The first speech part and the second speech part are of a same speech portion of the user's speech at a first interval in time. The first interval in time may be e.g. 20-25 ms long as the fundamental frequency may change for each “vocal sound” of the user's speech.

Thus, the first speech part and the second speech part are captured at the same time, or during the same time interval, but using two different input transducers. Thus, the first speech part and the second speech part comprise the same speech of the user but captured using different input transducers. The expression “same speech portion” may mean substantially the same speech portion, i.e. such as within 10%, or such as within 5%, or such as within 2%, or such as within 1%. The expression “same speech portion” may mean exactly the same speech portion.

The electronic device comprises a signal processor configured for processing the first sound signal and the second signal.

The method comprises, in the signal processor, estimating a first fundamental frequency of the user's speech at the first interval in time. Thus, the first fundamental frequency may be the first fundamental frequency of the user's voice for that specific speech portion in that interval in time. The user's voice may have a new first fundamental frequency for each new vocal sound of the user's speech. Thus each vocal sound of a user's speech portion may have a different first fundamental frequency. Different human's voices will have different frequencies, and thus the fundamental frequency of a speech portion spoken by different humans will be different.

The first fundamental frequency is estimated based on the second signal, because the second signal may have a clean speech signal. The second signal may have only a speech portion. The second signal may have no or only little noise portion, because the second signal is captured by the internal input transducer, where no or only little noise are present.

The method comprises, in the signal processor, applying the estimated first fundamental frequency of the user's speech at the first interval in time into a first model to update the first model. The first model may be a model of speech. The first model may be for deriving speech from a sound signal. The first model may be a periodic model. The first model may be a harmonic model. The first model may be a predefined model, which can be updated. The first model is updated by applying the estimated first fundamental frequency to the first model.

The first model may comprise one or more parameters. The fundamental frequency is one parameter of the first model. There may be more parameters of the first model, e.g. amplitude of the signal, and association filter, which parameters can be determined and applied to the first model.

The method comprises, in the signal processor, processing the first sound signal based on the updated first model to obtain the first speech part of the first sound signal. The processing of the first sound signal may be e.g. filtering or beamforming. The first speech part obtained from the first sound signal may be a substantially clean speech signal where no noise or only limited noise or little noise is left.

In an example, a harmonic filter may obtain a user's own-voice by means of pick-up using a first external microphone. A vibration sensor is an example of an internal input transducer. The vibration sensor captures a vibration signal which is an example of a second signal, and provides this signal to a pitch estimation which is a first fundamental frequency estimation. The pitch estimation estimates a pitch or a first fundamental frequency which is applied to a harmonic model which is an example of a first model. An external microphone is an example of a first external input transducer. The external microphone captures a sound signal, which is an example of a first sound signal, and provides this signal to a harmonic filter where the harmonic model is also provided. Based on this, the harmonic filter provides an own-voice signal which is an example of a first speech part.

In an example, a harmonic beamforming may obtain a user' own-voice by pick-up using at least two external microphones. A vibration sensor is an example of an internal input transducer. The vibration sensor captures a vibration signal which is an example of a second signal, and provides this signal to a pitch estimation which is a first fundamental frequency estimation. The pitch estimation estimates a pitch or a first fundamental frequency which is applied to a harmonic model which is an example of a first model. External microphones are an example of external input transducers, thus there may be at least a first external microphone and a second external microphones. The external microphones captures a sound signal, which is an example of a first sound signal, and provides this signal to a harmonic beamformer where the harmonic model is also provided. Based on this, the harmonic beamformer provides an own-voice signal which is an example of a first speech part.

In an example, spectrograms of signals, such as speech signals, may be provided. The spectrograms may show time in seconds on an x-axis, and frequency in kHz on an y-axis. Different spectrograms may be provided, such as a clean signal recorded with external microphones; the clean signal zoomed in at low frequencies between 0-1 kHz, a noisy external microphone signal corrupted by babble noise; the noisy signal zoomed in at low frequencies between 0-1 kHz; a vibration sensor signal; and the vibration sensor signal zoomed in at low frequencies between 0-1 kHz. The spectrograms may illustrate how the low frequencies are better preserved in the vibration sensor signal, whereas the high frequencies are better preserved in the external microphone signal. Therefore, it an advantage to use the vibration sensor signal to estimate the fundamental frequency of the user's speech, and based on this, obtain the first speech of the user's speech from the external microphone signal.

In an example, a speech signal may be shown in a first graph, where the x-axis is time in seconds, and the y-axis is amplitude. The speech signal may have a duration/length of 2.5 seconds.

The speech signal may be transformed to a frequency representation in a second graph, where the x-axis is time in seconds, and the y-axis is frequency in Hz. This frequency representation may show a spectrogram of speech, which corresponds to the spectrograms mentioned in the example above.

Going back to the speech signal in the first graph, this speech signal can be divided into segments of time. One segment of the speech signal may be shown in a third figure. The segment of the speech signal may have a length of 0.025 seconds. The periodicity of the speech signal in the specific segment may be illustrated vertical lines every 0.005 seconds.

The segment of the speech signal may be transformed to a frequency representation in a fourth graph, where the x-axis is now frequency in Hz, and the y-axis is power.

The fourth graph shows the corresponding spectrum of the segment. The fourth graph may show the signal divided in harmonic frequencies, where the harmonic frequency ω0 is the lowest frequency at about 25 Hz, the next harmonic is ω1 at about 50 Hz, and then a number of harmonics are shown up to about 100 Hz.

From the fourth graph showing the corresponding spectrum of the segment, a fundamental frequency ω0 of the speech segment may be estimated as shown in a fifth graph, where the x-axis is time in seconds, and the y-axis is fundamental frequency ω0 in Hz.

The estimated fundamental frequency in the fifth graph may be shown below the spectrum of speech in the second graph, and as the x-axes of both these graphs are time in seconds, the estimated fundamental frequency at a time tin the fifth graph can be seen together with the spectrum of speech at the same time tin the second graph. Thus, the graphs explained above may show how the fundamental frequency for time segments or time intervals can be estimated from a speech signal.

The electronic device may comprise an output transducer connected to the signal processor for outputting a signal, e.g. the first speech part of the first sound signal, processed in the signal processor, to the user's own ear canal. This allows the user to hear the obtained first speech part. Furthermore, the output transducer may be for providing a processed signal to the user's ear canal, e.g. a processed signal for compensating for a hearing loss of the user.

The first external input transducer of the electronic device may be configured to be arranged on an external facing surface of the electronic device to point towards the surroundings. The electronic device may further comprise a second external input transducer also arranged on an external facing surface of the electronic device to point towards the surroundings.

The first external input transducer and the second external input transducer may be arranged on a part, e.g. a housing, of the electronic device which is arranged in the ear of the user.

The electronic device may comprise a third external input transducer, e.g. arranged on a part of the electronic device, which is arranged behind the ear of the user.

In an embodiment, a hearing device is configured to be worn by a user. The hearing device may be arranged at the user's ear, on the user's ear, over the user's ear, in the user's ear, in the user's ear canal, behind the user's ear and/or in the user's concha, i.e., the hearing device is configured to be worn in, on, over and/or at the user's ear. The user may wear two hearing devices, one hearing device at each ear. The two hearing devices may be connected, such as wirelessly connected and/or connected by wires, such as a binaural hearing aid system.

The hearing device may be a hearable such as a headset, headphone, earphone, earbud, hearing aid, a personal sound amplification product (PSAP), an over-the-counter (OTC) hearing device, a hearing protection device, a one-size-fits-all hearing device, a custom hearing device or another head-wearable hearing device. Hearing devices can include both prescription devices and non-prescription devices.

The hearing device may be embodied in various housing styles or form factors. Some of these form factors are Behind-the-Ear (BTE) hearing device, Receiver-in-Canal (RIC) hearing device, Receiver-in-Ear (RIE) hearing device or Microphone-and-Receiver-in-Ear (MaRIE) hearing device. These devices may comprise a BTE unit configured to be worn behind the ear of the user and an in the ear (ITE) unit configured to be inserted partly or fully into the user's ear canal. Generally, the BTE unit may comprise at least one input transducer, a power source and a processing unit. The term BTE hearing device refers to a hearing device where the receiver, i.e. the output transducer, is comprised in the BTE unit and sound is guided to the ITE unit via a sound tube connecting the BTE and ITE units, whereas the terms RIE, RIC and MaRIE hearing devices refer to hearing devices where the receiver may be comprise in the ITE unit, which is coupled to the BTE unit via a connector cable or wire configured for transferring electric signals between the BTE and ITE units.

Some of these form factors are In-the-Ear (ITE) hearing device, Completely-in-Canal (CIC) hearing device or Invisible-in-Canal (IIC) hearing device. These hearing devices may comprise an ITE unit, wherein the ITE unit may comprise at least one input transducer, a power source, a processing unit and an output transducer. These form factors may be custom devices, meaning that the ITE unit may comprise a housing having a shell made from a hard material, such as a hard polymer or metal, or a soft material such as a rubber-like polymer, molded to have an outer shape conforming to the shape of the specific user's ear canal.

Some of these form factors are earbuds, on the ear headphones or over the ear headphones. The person skilled in the art is well aware of different kinds of hearing devices and of different options for arranging the hearing device in, on, over and/or at the ear of the hearing device wearer. The hearing device (or pair of hearing devices) may be custom fitted, standard fitted, open fitted and/or occlusive fitted.

In an embodiment, the hearing device may comprise one or more input transducers. The one or more input transducers may comprise one or more microphones. The one or more input transducers may comprise one or more vibration sensors configured for detecting bone vibration. The one or more input transducer(s) may be configured for converting an acoustic signal into a first electric input signal. The first electric input signal may be an analogue signal. The first electric input signal may be a digital signal. The one or more input transducer(s) may be coupled to one or more analogue-to-digital converter(s) configured for converting the analogue first input signal into a digital first input signal.

In an embodiment, the hearing device may comprise one or more antenna(s) configured for wireless communication. The one or more antenna(s) may comprise an electric antenna. The electric antenna may be configured for wireless communication at a first frequency. The first frequency may be above 800 MHz, preferably a wavelength between 900 MHz and 6 GHz. The first frequency may be 902 MHz to 928 MHz. The first frequency may be 2.4 to 2.5 GHz. The first frequency may be 5.725 GHz to 5.875 GHz. The one or more antenna(s) may comprise a magnetic antenna. The magnetic antenna may comprise a magnetic core. The magnetic antenna may comprise a coil. The coil may be coiled around the magnetic core. The magnetic antenna may be configured for wireless communication at a second frequency. The second frequency may be below 100 MHz. The second frequency may be between 9 MHz and 15 MHz.

In an embodiment, the hearing device may comprise one or more wireless communication unit(s). The one or more wireless communication unit(s) may comprise one or more wireless receiver(s), one or more wireless transmitter(s), one or more transmitter-receiver pair(s) and/or one or more transceiver(s). At least one of the one or more wireless communication unit(s) may be coupled to the one or more antenna(s). The wireless communication unit may be configured for converting a wireless signal received by at least one of the one or more antenna(s) into a second electric input signal. The hearing device may be configured for wired/wireless audio communication, e.g. enabling the user to listen to media, such as music or radio and/or enabling the user to perform phone calls.

In an embodiment, the wireless signal may originate from one or more external source(s) and/or external devices, such as spouse microphone device(s), wireless audio transmitter(s), smart computer(s) and/or distributed microphone array(s) associated with a wireless transmitter. The wireless input signal(s) may origin from another hearing device, e.g., as part of a binaural hearing system and/or from one or more accessory device(s), such as a smartphone and/or a smart watch.

In an embodiment, the hearing device may include a processing unit. The processing unit may be configured for processing the first and/or second electric input signal(s). The processing may comprise compensating for a hearing loss of the user, i.e., apply frequency dependent gain to input signals in accordance with the user's frequency dependent hearing impairment. The processing may comprise performing feedback cancelation, beamforming, tinnitus reduction/masking, noise reduction, noise cancellation, speech recognition, bass adjustment, treble adjustment and/or processing of user input. The processing unit may be a processor, an integrated circuit, an application, functional module, etc. The processing unit may be implemented in a signal-processing chip or a printed circuit board (PCB). The processing unit may be configured to provide a first electric output signal based on the processing of the first and/or second electric input signal(s). The processing unit may be configured to provide a second electric output signal. The second electric output signal may be based on the processing of the first and/or second electric input signal(s).

In an embodiment, the hearing device may comprise an output transducer. The output transducer may be coupled to the processing unit. The output transducer may be a receiver. It is noted that in this context, a receiver may be a loudspeaker, whereas a wireless receiver may be a device configured for processing a wireless signal. The receiver may be configured for converting the first electric output signal into an acoustic output signal. The output transducer may be coupled to the processing unit via the magnetic antenna. The output transducer may be comprised in an ITE unit or in an earpiece, e.g. Receiver-in-Ear (RIE) unit or Microphone-and-Receiver-in-Ear (MaRIE) unit, of the hearing device. One or more of the input transducer(s) may be comprised in an ITE unit or in an earpiece.

In an embodiment, the wireless communication unit may be configured for converting the second electric output signal into a wireless output signal. The wireless output signal may comprise synchronization data. The wireless communication unit may be configured for transmitting the wireless output signal via at least one of the one or more antennas.

In an embodiment, the hearing device may comprise a digital-to-analogue converter configured to convert the first electric output signal, the second electric output signal and/or the wireless output signal into an analogue signal.

In an embodiment, the hearing device may comprise a vent. A vent is a physical passageway such as a canal or tube primarily placed to offer pressure equalization across a housing placed in the ear such as an ITE hearing device, an ITE unit of a BTE hearing device, a CIC hearing device, a RIE hearing device, a RIC hearing device, a MaRIE hearing device or a dome tip/earmold. The vent may be a pressure vent with a small cross section area, which is preferably acoustically sealed. The vent may be an acoustic vent configured for occlusion cancellation. The vent may be an active vent enabling opening or closing of the vent during use of the hearing device. The active vent may comprise a valve.

In an embodiment, the hearing device may comprise a power source. The power source may comprise a battery providing a first voltage. The battery may be a rechargeable battery. The battery may be a replaceable battery. The power source may comprise a power management unit. The power management unit may be configured to convert the first voltage into a second voltage. The power source may comprise a charging coil. The charging coil may be provided by the magnetic antenna.

In an embodiment, the hearing device may comprise a memory, including volatile and non-volatile forms of memory.

The hearing device is configured to be arranged at a user's ear. The hearing device may be arranged inside the user's ear. The hearing device may be arranged behind the user's ear. The hearing device may be arranged in the user's ear. The hearing device may be arranged at a close vicinity of the user's ear. The hearing device may have a component adapted to be arranged behind the user's ear and a component adapted to be arranged in the user's ear.

The hearing device comprises an input transducer for generating one or more input signals based on a received audio signal. An example of an input transducer is a microphone.

The hearing device comprises a signal processor configured for processing the one or more input signals. The signal processor may process signals such as to provide for a specified hearing device functionality. The signal processor may process signals such as to compensate for the user's hearing loss or hearing impairment, such compensation may involve frequency dependent amplification of the input signal based on the user's hearing loss. The signal processor may provide a modified signal. The signal processor may process signals such as to provide Tinnitus masking. The signal processor may process signals such as to provide for streaming of audio signals.

The hearing device comprises an output transducer for providing an audio output signal based on an output signal from the signal processor. The output transducer is coupled to an output of the signal processer for conversion of an output signal from the signal processor into an audio output signal. Examples of the output transducer are receivers, such as a speaker, for generating an audio output signal or a cochlear implant for generating an electric stimulus signal to the auditory nerve of the user.

The hearing device may be a headset, a hearing aid, a hearable etc. The hearing device may be an in-the-ear (ITE) hearing device, a receiver-in-ear (RIE) hearing device, a receiver-in-canal (RIC) hearing device, a microphone-and-receiver-in-ear (MaRIE) hearing device, a behind-the-ear (BTE) hearing device, an over-the-counter (OTC) hearing device etc, a one-size-fits-all hearing device etc.

The hearing device is configured to be worn by a user. The hearing device may be arranged at the user's ear, on the user's ear, in the user's ear, in the user's ear canal, behind the user's ear etc. The user may wear two hearing devices, one hearing device at each ear. The two hearing devices may be connected, such as wirelessly connected.

The hearing device may be configured for audio communication, e.g. enabling the user to listen to media, such as music or radio, and/or enabling the user to perform phone calls. The hearing device may be configured for performing hearing compensation for the user. The hearing device may be configured for performing noise cancellation etc.

The hearing device may comprise a first input transducer, e.g. a microphone, to generate one or more microphone output signals based on a received audio signal. The audio signal may be an analogue signal. The microphone output signal may be a digital signal. Thus, the first input transducer, e.g. microphone, or an analogue-to-digital converter, may convert the analogue audio signal into a digital microphone output signal. All the signals may be sound signals or signals comprising information about sound. The hearing device may comprise a signal processor. The one or more microphone output signals may be provided to the signal processor for processing the one or more microphone output signals. The signals may be processed such as to compensate for a user's hearing loss or hearing impairment. The signal processor may provide a modified signal. All these components may be comprised in a housing of an ITE unit or a BTE unit. The hearing device may comprise a receiver or output transducer or speaker or loudspeaker. The receiver may be connected to an output of the signal processor. The receiver may output the modified signal into the user's ear. The receiver, or a digital-to-analogue converter, may convert the modified signal, which is a digital signal, from the processor to an analogue signal. The receiver may be comprised in an ITE unit or in an earpiece, e.g. RIE unit or MaRIE unit. The hearing device may comprise more than one microphone, and the ITE unit or BTE unit may comprise at least one microphone and the RIE unit may also comprise at least one microphone.

The hearing device signal processor may comprise elements such as an amplifier, a compressor and/or a noise reduction system etc. The signal processor may be implemented in a signal-processing chip or a printed circuit board (PCB). The hearing device may further have a filter function, such as compensation filter for optimizing the output signal.

The hearing device may comprise one or more antennas for radio frequency communication. The one or more antenna may be configured for operation in ISM frequency band. One of the one or more antennas may be an electric antenna. One or the one or more antennas may be a magnetic induction coil antenna. Magnetic induction, or near-field magnetic induction (NFMI), typically provides communication, including transmission of voice, audio and data, in a range of frequencies between 2 MHz and 15 MHz. At these frequencies the electromagnetic radiation propagates through and around the human head and body without significant losses in the tissue.

The magnetic induction coil may be configured to operate at a frequency below 100 MHz, such as at below 30 MHz, such as below 15 MHz, during use. The magnetic induction coil may be configured to operate at a frequency range between 1 MHz and 100 MHz, such as between 1 MHz and 15 MHz, such as between 1 MHz and 30 MHz, such as between 5 MHz and 30 MHz, such as between 5 MHz and 15 MHz, such as between 10 MHz and 11 MHz, such as between 10.2 MHz and 11 MHz. The frequency may further include a range from 2 MHz to 30 MHz, such as from 2 MHz to 10 MHz, such as from 2 MHz to 10 MHz, such as from 5 MHz to 10 MHz, such as from 5 MHz to 7 MHz.

The electric antenna may be configured for operation at a frequency of at least 400 MHz, such as of at least 800 MHz, such as of at least 1 GHz, such as at a frequency between 1.5 GHz and 6 GHz, such as at a frequency between 1.5 GHz and 3 GHz such as at a frequency of 2.4 GHz. The antenna may be optimized for operation at a frequency of between 400 MHz and 6 GHz, such as between 400 MHz and 1 GHz, between 800 MHz and 1 GHz, between 800 MHz and 6 GHz, between 800 MHz and 3 GHz, etc. Thus, the electric antenna may be configured for operation in ISM frequency band. The electric antenna may be any antenna capable of operating at these frequencies, and the electric antenna may be a resonant antenna, such as monopole antenna, such as a dipole antenna, etc. The resonant antenna may have a length of λ/4±10% or any multiple thereof, λ being the wavelength corresponding to the emitted electromagnetic field.

The hearing device may comprise one or more wireless communications unit(s) or radios. The one or more wireless communications unit(s) are configured for wireless data communication, and in this respect interconnected with the one or more antennas for emission and reception of an electromagnetic field. Each of the one or more wireless communication unit may comprise a transmitter, a receiver, a transmitter-receiver pair, such as a transceiver, and/or a radio unit. The one or more wireless communication units may be configured for communication using any protocol as known for a person skilled in the art, including Bluetooth, WLAN standards, manufacture specific protocols, such as tailored proximity antenna protocols, such as proprietary protocols, such as low-power wireless communication protocols, RF communication protocols, magnetic induction protocols, etc. The one or more wireless communication units may be configured for communication using same communication protocols, or same type of communication protocols, or the one or more wireless communication units may be configured for communication using different communication protocols.

The wireless communication unit may connect to the hearing device signal processor and the antenna, for communicating with one or more external devices, such as one or more external electronic devices, including at least one smart phone, at least one tablet, at least one hearing accessory device, including at least one spouse microphone, remote control, audio testing device, etc., or, in some embodiments, with another hearing device, such as another hearing device located at another ear, typically in a binaural hearing device system.

The hearing device may be a binaural hearing device. The hearing device may be a first hearing device and/or a second hearing device of a binaural hearing device.

The hearing device may be a device configured for communication with one or more other device, such as configured for communication with another hearing device or with an accessory device or with a peripheral device.

The hearing device may be any hearing device, such as any hearing device compensating a hearing loss of a wearer of the hearing device, or such as any hearing device providing sound to a wearer, or such as a hearing device providing noise cancellation, or such as a hearing device providing tinnitus reduction/masking. The person skilled in the art is well aware of different kinds of hearing devices and of different options for arranging the hearing device in and/or at the ear of the hearing device wearer.

For example, the hearing device may be an In-The-Ear (ITE), Receiver-In-Canal (RIC) or Receiver-In-the-Ear (RIE or RITE) or a Microphone-and-Receiver-In-the-Ear (MaRIE) type hearing device, in which a receiver is positioned in the ear, such as in the ear canal, of a wearer during use, for example as part of an in-the-ear unit, while other hearing device components, such as a processor, a wireless communication unit, a battery, etc. are provided as an assembly and mounted in a housing of a Behind-The-Ear (BTE) unit. A plug and socket connector may connect the BTE unit and the earpiece, e.g. RIE unit or MaRIE unit.

The hearing device may comprise a RIE unit. The RIE unit typically comprises the earpiece such as a housing, a plug connector, and an electrical wire/tube connecting the plug connector and earpiece. The earpiece may comprise an in-the-ear housing, a receiver, such as a receiver configured for being provided in an ear of a user and/or a receiver being configured for being provided in an ear canal of a user, and an open or closed dome. The dome may support correct placement of the earpiece in the ear of the user. The RIE unit may comprise a microphone, a receiver, one or more sensors, and/or other electronics. Some electronic components may be placed in the earpiece, while other electronic components may be placed in the plug connector. The receiver may be with a different strength, i.e. low power, medium power, or high power. The electrical wire/tube provides an electrical connection between electronic components provided in the earpiece of the RIE unit and electronic components provided in the BTE unit. The electrical wire/tube as well as the RIE unit itself may have different lengths.

The method and processing may be repeated for each new time interval, e.g. every 10 ms or every 20-25 ms, when a new vocal sound is in the speech portion. The following embodiment covers the next interval in time called the second interval in time to distinguish from the first interval in time used above and in claim 1.

In some embodiments, the first external input transducer is configured for capturing a third sound signal, the third sound signal comprising a third speech part of the user's speech and a third noise part. The internal input transducer is configured for capturing a fourth signal, the fourth signal comprising a fourth speech part of the user's speech. The third speech part and the fourth speech part are of a same speech portion of the user's speech at a second interval in time. The signal processor may be configured for processing the third sound signal and the fourth signal. Where the method comprises, in the signal processor:

estimating a second fundamental frequency of the user's speech at the second interval in time, the second fundamental frequency being estimated based on the fourth signal;

applying the estimated second fundamental frequency of the user's speech at the second interval in time into the first model to update the first model;

processing the third sound signal based on the updated first model to obtain the third speech part of the third sound signal.

Thus, in this embodiment, new signals, called third sound signal and fourth signal, are captured, a new fundamental frequency, called second fundamental frequency, is estimated, which is used in the same first model as defined above and in claim 1, to update the first model.

The method and processing may be repeated for each new time interval, e.g. every 10 ms or every 20-25 ms, when a new vocal sound is in the speech portion. The following embodiment covers the general repetition of the method for each new time interval of the speech.

In some embodiments, the method is configured to be performed at regular intervals in time for obtaining the user's speech during/over a time period,

where the method comprises estimating the current fundamental frequency of the user's speech at each interval in time;

where the method comprises applying the current fundamental frequency in the first model to update the first model;

where the method comprises obtaining a current speech part at each interval in time.

The method is configured to be performed at regular intervals in time such as every 10 ms or every 20-25 ms. A new vocal sound may be present in the user's speech every 10 ms or 20-25 ms. Several time intervals of e.g. 20-25 ms may be present in the entire time period during which the speech is obtained. The time period when the user's speech is obtained may be e.g during a phone call, or during a voice controlled instruction, or during an examination of the user's voice, e.g. for medical purposes, etc. The method comprises estimating the current fundamental frequency of the user's speech at each interval in time, as the fundamental frequency many change for each vocal sound in the user's speech. The method comprises applying the current fundamental frequency in the first model to update the first model. The method comprises obtaining a current speech part at each interval in time. The current speech part will be a substantially clean speech signal with no noise or only limited noise or only little noise from the surroundings.

The method and processing may be repeated regularly. The first model may be updated regularly. The method and processing may be repeated continuously. The first model may be updated continuously.

In some embodiments, the first model is a periodic model. The first model and the periodic model may be a harmonic model.

In some embodiments, processing the first sound signal, which is based on the updated first model to obtain the first speech part, comprises filtering the first sound signal in a periodic filter. The periodic filter may be e.g. a symmetric filter, a harmonic filter, a comp filter, a chirp filter etc.

In some embodiments, filtering the first sound signal in the periodic filter comprises applying multiples of the estimated first fundamental frequency of the user's speech. Thus, filtering the first sound signal in the periodic filter may comprise filtering in multitudes the estimated first fundamental frequency of the user's speech.

In some embodiments, the periodic model is a harmonic model, and the periodic filter is a harmonic filter.

In some embodiments, the method further comprises processing the obtained first speech part; and wherein the processing of the obtained first speech part comprises mixing a noise signal with the obtained first speech part. It may be an advantage to mix a noise signal with the obtained first speech part, as this may make a transmitted first speech part sound more natural if there is also some noise in it.

In some embodiments, the internal input transducer is configured to be arranged in the ear canal of the user or on the body of the user. The internal input transducer may e.g. be arranged on the user's wrist.

In some embodiments, the internal input transducer comprises or is a vibration sensor. Thus, the internal input transducer may be a sensor configured for measuring vibration signals. The vibration may be in the user's body and coming from the user's voice. Alternatively, the internal input transducer may a microphone for capturing sound signals of the user's voice.

In some embodiments, the bandwidth of the vibration sensor is configured to span low frequencies of the user's speech, the low frequencies being up to approximately 1.5 kHz. Thus, the vibration sensor may not capture the entire speech spectrum but only the low frequencies where the fundamental frequency of the user's voice is present. The low frequencies may be up to approximately 1.5 kHz, such as up to about 1 kHz, such as up to about 1.2 kHz, such as up to about 1.4 kHz, such as up to about 1.6 kHz, such as up to about 1.8 kHz, such as up to about 2 kHz. Approximately 1.5 kHz may be 1.5 kHz+/−15%. Approximately 1.5 kHz may be 1.5 kHz+/−10%. Approximately 1.5 kHz may be 1.5 kHz+/−5%.

In some embodiments, the first external input transducer is a microphone configured to point towards the surroundings. Thus, the microphone may be arranged on an external facing surface of the electronic device.

In some embodiments, the electronic device further comprises a second external input transducer, and wherein processing the first sound signal, which is based on the updated first model to obtain the first speech part, comprises beamforming the first sound signal in a periodic beamformer.

The electronic device may comprise a third external input transducer, a fourth external input transducer etc. The first sound signal may enter both the first external input transducer and the second external input transducer. If there are more external input transducers, the first sound signal may also enter these further external input transducers. The first sound signal may be beamformed in a periodic beamformer. The periodic beamformer may be e.g. a harmonic beamformer, a comp beamformer, a chirp beamformer etc.

In some embodiments, the electronic device comprises a first hearing device and a second hearing device, and wherein the first fundamental frequency is configured to be estimated in the first hearing device and/or in the second hearing device. Thus, the method comprises estimating the first fundamental frequency in the first hearing device and/or in the second hearing device. The first hearing device and the second hearing device may be binaural hearing devices configured to be arranged in the left and right ear of the user. Alternatively, the electronic device may comprise just one hearing device, e.g. a first hearing device. The hearing device(s) may e.g. hearing aids, a headset, a hearable, earphones, ear buds etc.

The method may further comprises estimating the second, third, fourth etc. fundamental frequency in the first hearing device and/or in the second hearing device.

Thus, the fundamental frequency (pitch) can both be estimated unilateral, i.e. in one hearing device, but also bilateral, i.e. in two hearing devices, using a multi-channel pitch estimator to achieve a better pitch estimate by taking advantage of the fact the own-voice signal should be equally present at the internal input transducers, e.g. vibration sensors, in both ears.

There are a number of combinations possible, e.g. if the internal input transducer, e.g. vibration sensor, in the left ear provides a better signal, then the left ear internal input transducer, e.g. vibration sensor, may be used for both ears. If only one internal input transducer is present, then use this internal input transducer for both ears etc.

The present disclosure relates to different aspects including the method and electronic device described above and in the following, and corresponding methods, devices, systems, networks, kits, uses and/or product means, each yielding one or more of the benefits and advantages described in connection with the first mentioned aspect, and each having one or more embodiments corresponding to the embodiments described in connection with the first mentioned aspect and/or disclosed in the appended claims.

### BRIEF DESCRIPTION OF THE DRAWINGS

The above and other features and advantages will become readily apparent to those skilled in the art by the following detailed description of exemplary embodiments thereof with reference to the attached drawings, in which:

FIG. 1 schematically illustrates an example of a method in an electronic device, for obtaining a user's speech in a first sound signal.

FIGS. 2A and 2B schematically illustrate examples of an electronic device for obtaining a user's speech in a first sound signal.

FIG. 3 schematically illustrates an example of a user's ear with an electronic device in the ear.

FIG. 4 schematically illustrates an example of using the obtained first speech part in a phone call between the user of the electronic device and a far-end caller or recipient.

FIGS. 5A and 5B schematically illustrate examples of block diagrams of a method for obtaining a first speech part of a first sound signal, where FIG. 5A schematically illustrates an example of a block diagram for harmonic filter own-voice pick-up using a first external microphone, and where FIG. 5B schematically illustrates an example of a block diagram for harmonic beamformer own-voice pick-up using at least two external microphones.

FIG. 6 shows examples of spectrograms of speech signals.

FIGS. 7A and 7B schematically illustrates examples of beamformers.

FIG. 8 schematically illustrates an example of representations and segments of a speech signal, and how the fundamental frequency for time segments or time intervals can be estimated from a speech signal.

### DETAILED DESCRIPTION

Various embodiments are described hereinafter with reference to the figures. Like reference numerals refer to like elements throughout. Like elements will, thus, not be described in detail with respect to the description of each figure. It should also be noted that the figures are only intended to facilitate the description of the embodiments. They are not intended as an exhaustive description of the claimed invention or as a limitation on the scope of the claimed invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

Throughout, the same reference numerals are used for identical or corresponding parts.

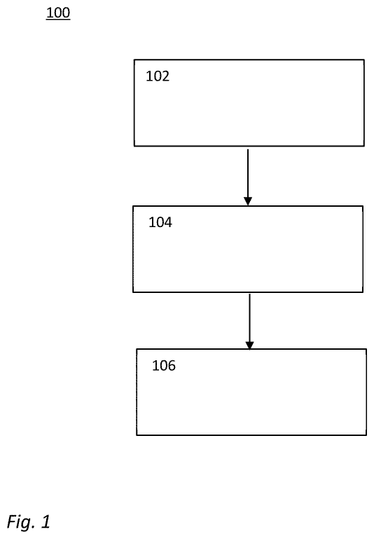

FIG. 1 schematically illustrates an example of a method 100 in an electronic device, for obtaining a user's speech in a first sound signal. The first sound signal comprising the user's speech and noise from the surroundings. The electronic device comprises a first external input transducer configured for capturing the first sound signal. The first sound signal comprising a first speech part of the user's speech and a first noise part. The electronic device comprises an internal input transducer configured for capturing a second signal. The second signal comprising a second speech part of the user's speech. The first speech part and the second speech part are of a same speech portion of the user's speech at a first interval in time. The electronic device comprises a signal processor. The signal processor may be configured for processing the first sound signal and the second signal. The method comprises, in the signal processor, estimating 102 a first fundamental frequency of the user's speech at the first interval in time. The first fundamental frequency being estimated based on the second signal. The method comprises, in the signal processor, applying 104 the estimated first fundamental frequency of the user's speech at the first interval in time into a first model to update the first model. The method comprises, in the signal processor, processing 106 the first sound signal based on the updated first model to obtain the first speech part of the first sound signal.

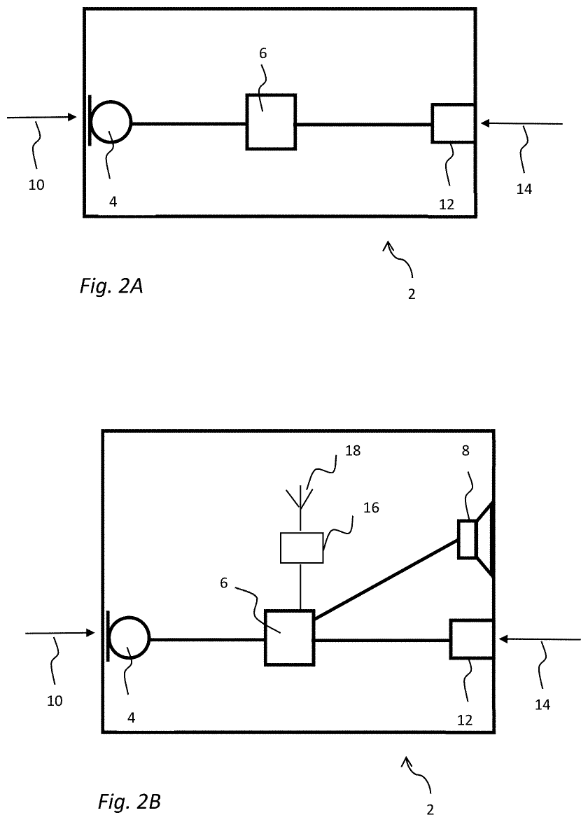

FIG. 2A schematically illustrates an example of an electronic device 2 for obtaining a user's speech in a first sound signal 10. The first sound signal 10 comprises the user's speech and noise from the surroundings. The electronic device 2 comprises a first external input transducer 4 configured for capturing the first sound signal 10. The first sound signal 10 comprising a first speech part of the user's speech and a first noise part. The electronic device 2 comprises an internal input transducer 12 configured for capturing a second signal 14. The second signal 14 comprising a second speech part of the user's speech. Where the first speech part and the second speech part are of a same speech portion of the user's speech at a first interval in time. The electronic device 2 comprises a signal processor 6. The signal processor 6 may be configured for processing the first sound signal 10 and the second signal 14. Where the signal processor 6 is configured to:

estimating a fundamental frequency of the user's speech at the first interval in time, the fundamental frequency being estimated based on the second signal 14;

applying the estimated fundamental frequency of the user's speech at the first interval in time into a first model to update the first model;

processing the first sound signal 16 based on the updated first model to obtain the first speech part of the first sound signal.

FIG. 2B schematically illustrates an example of an electronic device 2 for obtaining a user's speech in a first sound signal 10. The electronic device of FIG. 2B comprises the same features as in FIG. 2A. Furthermore, FIG. 2B shows that the electronic device 2 may also comprise an output transducer 8 connected to the signal processor 6 for outputting a signal, e.g. the first speech part of the first sound signal, processed in the signal processor 6 to the user's own ear canal. Furthermore, FIG. 2B shows that the electronic device 2 may also comprise a transceiver 16 and an antenna 18 for transmitting the signal, e.g. the first speech part of the first sound signal, processed in the signal processor 6 to e.g. another device, such as a smart phone paired with the electronic device. Phone calls with far-end callers may be performed using the smart phone, whereby the first speech part of the first sound signal may be transmitted in the phone call to the far-end caller.

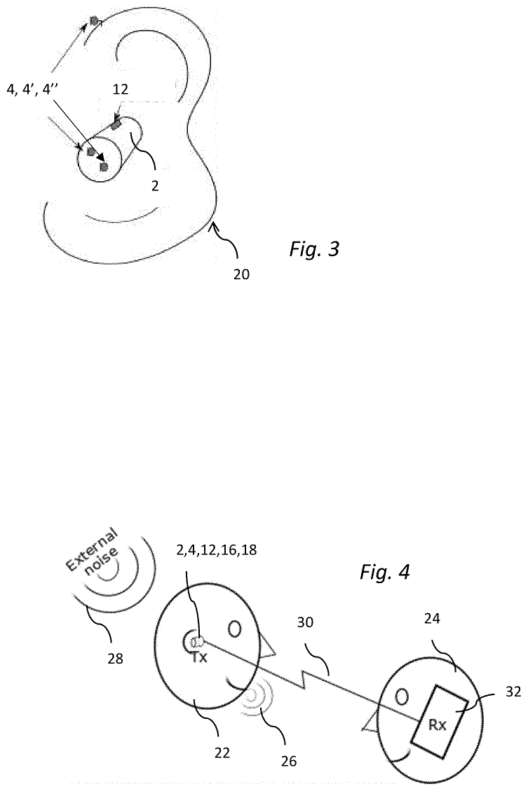

FIG. 3 schematically illustrates an example of a user's ear 20 with an electronic device 2 in the ear 20. The electronic device 2 comprises a first external input transducer 4 which may be a microphone configured to be arranged on an external facing surface of the electronic device 2 to point towards the surroundings. The electronic device 2 may further comprise a second external input transducer 4′ also arranged on an external facing surface of the electronic device 2 to point towards the surroundings.

The first external input transducer 4 and the second external input transducer 4′ may be arranged on a part, e.g. a housing, of the electronic device 2 which is arranged in the ear 2 of the user.

The electronic device 2 may comprise a third external input transducer 4″, e.g. arranged on a part of the electronic device which is arranged behind the ear 20 of the user.

The electronic device 2 comprises an internal input transducer 12 which is configured to be arranged in the ear canal of the user's ear 20. Alternatively, the internal input transducer 12 may be arranged on the body of the user, e.g. arranged on the user's wrist.

FIG. 4 schematically illustrates an example of using the obtained first speech part in a phone call between the user 22 of the electronic device and a far-end caller or recipient 24. When the user 22 of the electronic device 2 speaks, the first external input transducer 4 of the electronic device 2 may capture both the user's speech 26 and sounds 28 from the surroundings. If the user 22 of the electronic device 2 is having a phone call via a wireless connection 30 with a far-end caller 24, the user's speech 26 may be captured by the external input transducer 4 of the electronic device 2 and transmitted to the far-end caller 24. However, as the external input transducer 4 may capture both the user's speech 26 and sounds 28 from the surroundings, the sounds 28 from the surroundings may be perceived as noise in a phone call, where it is desired to only transmit the user's speech 26 and not the sound/noise 28 from the surroundings. According to the present method and electronic device, the user's speech 26 or own-voice is obtained from the first sound signal, with no noise 28 or limited noise 28 or only little noise 28 in the signal. Thus, the first speech part is transmitted via the wireless connection 30 to the far-end recipient 24, whereby the far-end recipient 24 receives the first speech signal and not the noise signal 28 of the first sound signal. Thereby will the far-end recipient 24 receive a clean speech signal and no sounds/noise 28 or only few sounds/little noise 28 from the surroundings of the user 26.

Thus, the electronic device 2 may comprise a transceiver 16 and an antenna 18 for transmitting 30 the signal, e.g. the first speech part of the first sound signal, processed in the signal processor 6 to another device, such as a smart phone paired with the electronic device 2. Phone calls with far-end callers 24 may be performed using the smart phone, whereby the first speech part of the first sound signal may be transmitted via the wireless connection 30 in the phone call to a transceiver 32 of a second electronic device, such as a smart phone of the far-end caller 24.

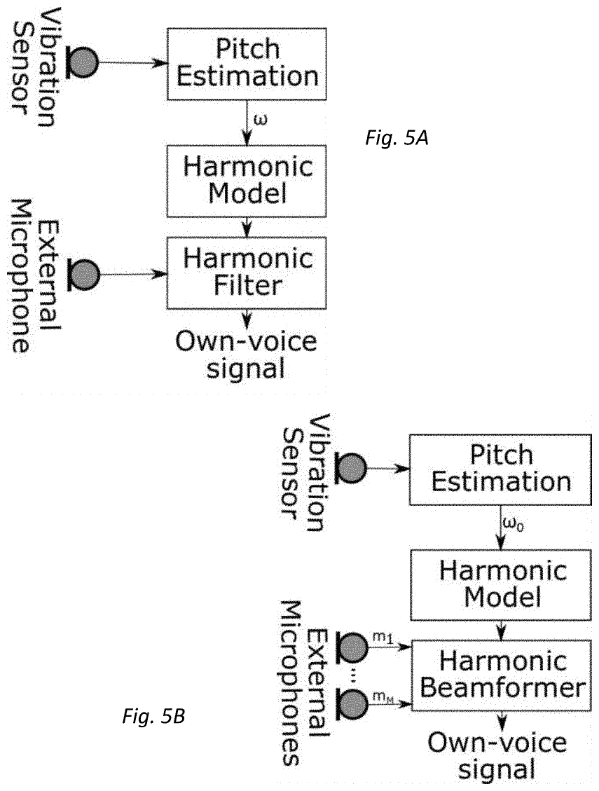

FIGS. 5a and 5b schematically illustrate examples of block diagrams of a method for obtaining a first speech part of a first sound signal.

FIG. 5A schematically illustrates an example of a block diagram for harmonic filter own-voice pick-up using a first external microphone. A vibration sensor is an example of an internal input transducer 12. The vibration sensor captures a vibration signal which is an example of a second signal, and provides this signal to a pitch estimation which is a first fundamental frequency estimation. The pitch estimation estimates a pitch or a first fundamental frequency ω which is applied to a harmonic model which is an example of a first model. An external microphone is an example of a first external input transducer 4. The external microphone captures a sound signal, which is an example of a first sound signal, and provides this signal to a harmonic filter where the harmonic model is also provided. Based on this, the harmonic filter provides an own-voice signal which is an example of a first speech part.

FIG. 5B schematically illustrates an example of a block diagram for harmonic beamforming own-voice pick-up using at least two external microphones. A vibration sensor is an example of an internal input transducer 12. The vibration sensor captures a vibration signal which is an example of a second signal, and provides this signal to a pitch estimation which is a first fundamental frequency estimation. The pitch estimation estimates a pitch or a first fundamental frequency ω0 which is applied to a harmonic model which is an example of a first model. External microphones are an example of external input transducers, thus there may be at least a first external microphone 4 and a second external microphones 4′. The external microphones captures a sound signal, which is an example of a first sound signal, and provides this signal to a harmonic beamformer where the harmonic model is also provided. Based on this, the harmonic beamformer provides an own-voice signal which is an example of a first speech part.

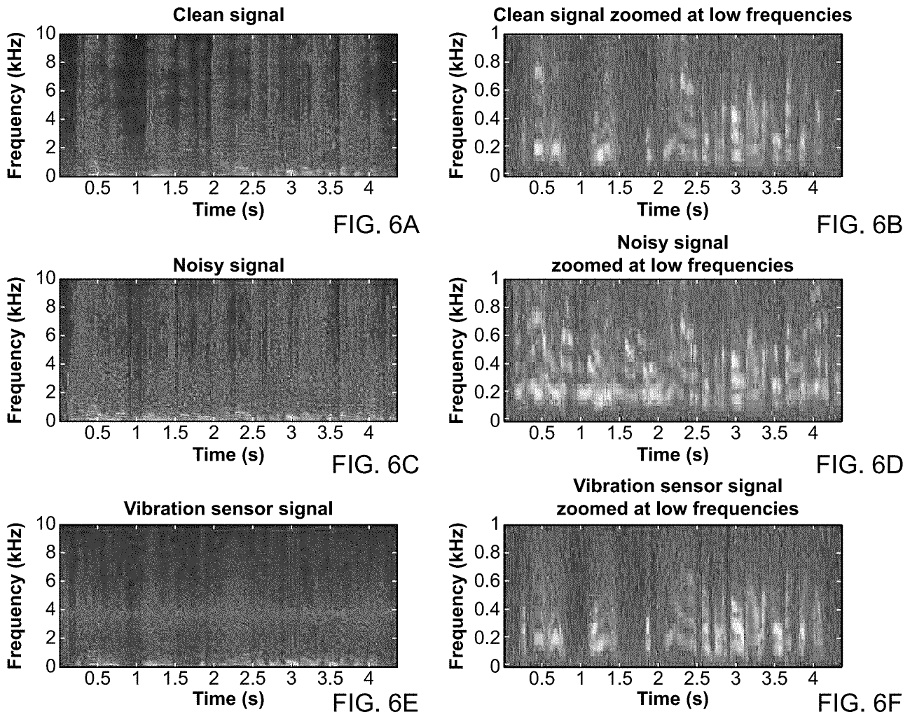

FIG. 6 shows examples of spectrograms. The spectrograms are of signals, such as speech signals. The x-axis is time in seconds. The y-axis is frequency in kHz.

(a) is a clean signal recorded with external microphones.
(b) is the clean signal zoomed in at low frequencies between 0-1 kHz.
(c) is the noisy external microphone signal corrupted by babble noise.
(d) is the noisy signal zoomed in at low frequencies between 0-1 kHz.
(e) is the vibration sensor signal.
(f) is the vibration sensor signal zoomed in at low frequencies between 0-1 kHz.

The spectrograms illustrate how the low frequencies are better preserved in the vibration sensor signal, whereas the high frequencies are better preserved in the external microphone signal. Therefore it an advantage to use the vibration sensor signal to estimate the fundamental frequency of the user's speech, and based on this, obtain the first speech of the user's speech from the external microphone signal.

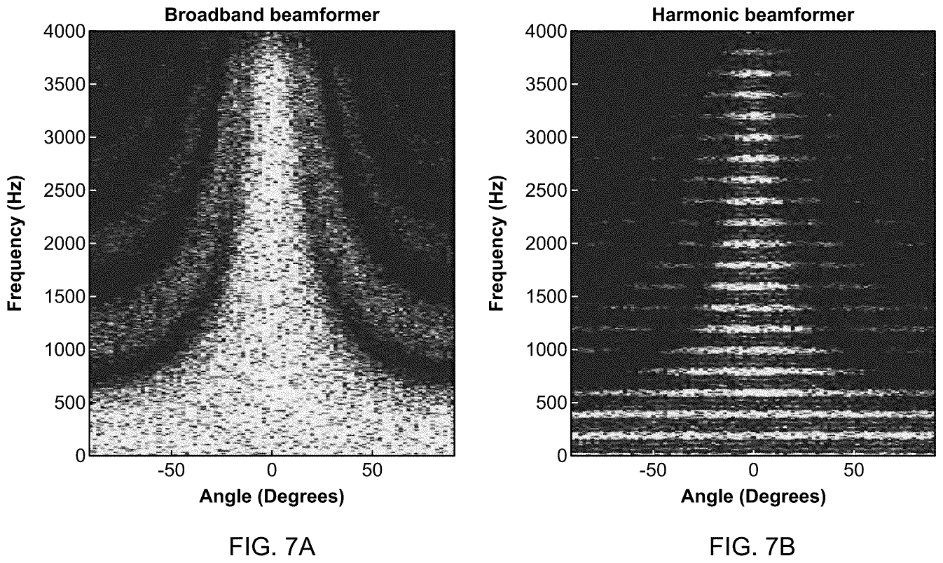

FIGS. 7A and 7B schematically illustrates examples of beamformers. The x-axis is angle in degrees. The y-axis is frequency in Hz.

FIG. 7A schematically illustrates an example of a broadband beamformer. FIG. 7B schematically illustrates an example of a harmonic beamformer.

FIG. 7a shows the beampattern of a broadband beamformer with its directivity steered to 0 degrees preserving most of the signal along an entire lobe from 0 Hz to 4000 Hz.

FIG. 7b shows the beampattern of a harmonic beamformer with its directivity steered to 0 degrees and is only preserving the signal at the harmonic frequencies distributed from 0 Hz to 4000 Hz, while eliminating the interference between the harmonic frequencies.

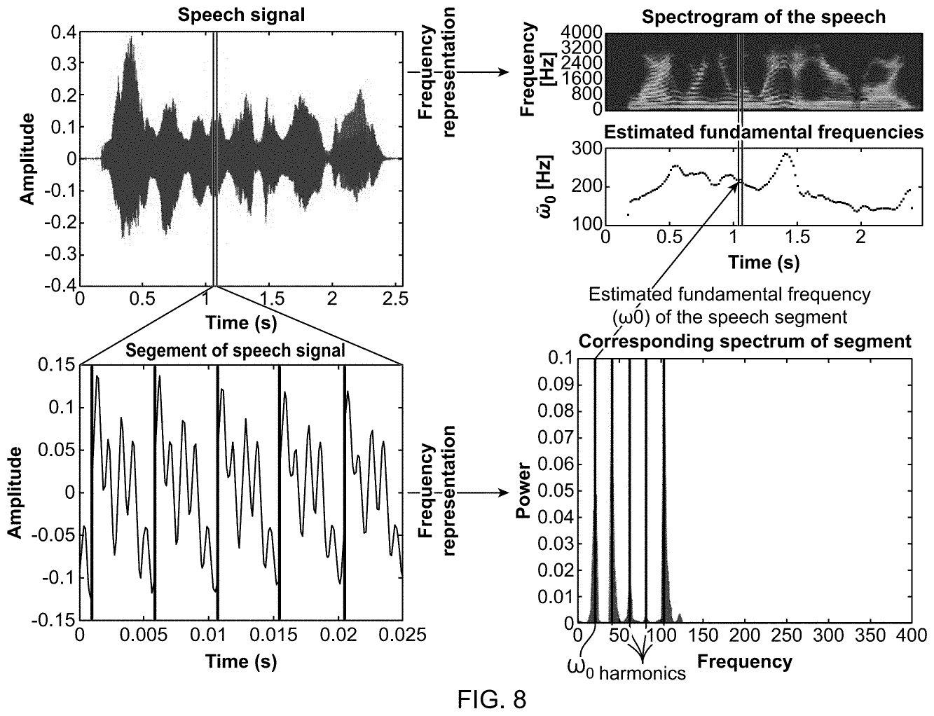

FIG. 8 schematically illustrates an example of representations and segments of a speech signal, and how the fundamental frequency for time segments or time intervals can be estimated from a speech signal.

The top left graph shows a speech signal, where the x-axis is time in seconds, and the y-axis is amplitude. The speech signal has a duration/length of 2.5 seconds.

The speech signal is transformed to a frequency representation in the top right graph, where the x-axis is time in seconds, and the y-axis is frequency in Hz. This frequency representation shows a spectrogram of speech, which corresponds to the spectrograms in FIG. 6.

Going back to the speech signal in the top left graph, this speech signal can be divided into segments of time. One segment of the speech signal is shown in the bottom left figure. The segment of the speech signal has a length of 0.025 seconds. The periodicity of the speech signal in the specific segment is illustrated by the red vertical lines every 0.005 seconds.

The segment of the speech signal is transformed to a frequency representation in the bottom right graph, where the x-axis is now frequency in Hz, and the y-axis is power.

The bottom right graph shows the corresponding spectrum of the segment. The bottom right graph shows the signal divided in harmonic frequencies, where the harmonic frequency ω0 is the lowest frequency at about 25 Hz, the next harmonic is ω1 at about 50 Hz, and then a number of harmonics are shown up to about 100 Hz.

From the bottom right graph showing the corresponding spectrum of the segment, a fundamental frequency ω0 of the speech segment is estimated as shown in the middle right graph, where the x-axis is time in seconds, and the y-axis is fundamental frequency ω0 in Hz.

The estimated fundamental frequency in the middle right graph is shown below the spectrum of speech in the top right graph, and as the x-axes of both these graphs are time in seconds, the estimated fundamental frequency at a time tin the middle right graph can be seen together with the spectrum of speech at the same time t in the top right graph. Thus, the graphs of FIG. 8 show how the fundamental frequency for time segments or time intervals can be estimated from a speech signal.

Although particular features have been shown and described, it will be understood that they are not intended to limit the claimed invention, and it will be made obvious to those skilled in the art that various changes and modifications may be made without departing from the scope of the claimed invention. The specification and drawings are, accordingly to be regarded in an illustrative rather than restrictive sense. The claimed invention is intended to cover all alternatives, modifications and equivalents.

Items:

1. A method in an electronic device, for obtaining a user's speech in a first sound signal, the first sound signal comprising the user's speech and noise from the surroundings, the electronic device comprising:
a first external input transducer configured for capturing the first sound signal, the first sound signal comprising a first speech part of the user's speech and a first noise part;
an internal input transducer configured for capturing a second signal, the second signal comprising a second speech part of the user's speech;
   where the first speech part and the second speech part are of a same speech portion of the user's speech at a first interval in time;
a signal processor;
   where the method comprises, in the signal processor:
estimating a first fundamental frequency of the user's speech at the first interval in time, the first fundamental frequency being estimated based on the second signal;
applying the estimated first fundamental frequency of the user's speech at the first interval in time into a first model to update the first model; and
processing the first sound signal based on the updated first model to obtain the first speech part of the first sound signal.
   2. The method according to any of the preceding items, wherein
   the first external input transducer is configured for capturing a third sound signal, the third sound signal comprising a third speech part of the user's speech and a third noise part;
   the internal input transducer is configured for capturing a fourth signal, the fourth signal comprising a fourth speech part of the user's speech;
   where the third speech part and the fourth speech part are of a same speech portion of the user's speech at a second interval in time;
   where the method comprises, in the signal processor:
estimating a second fundamental frequency of the user's speech at the second interval in time, the second fundamental frequency being estimated based on the fourth signal;
applying the estimated second fundamental frequency of the user's speech at the second interval in time into the first model to update the first model;
processing the third sound signal based on the updated first model to obtain the third speech part of the third sound signal.
   3. The method according to any of the preceding items,
   wherein the method is configured to be performed at regular intervals in time for obtaining/deriving the user's speech during/over a time period,
   where the method comprises estimating the current fundamental frequency of the user's speech at each interval in time;
   where the method comprises applying the current fundamental frequency in the first model to update the first model;
   where the method comprises obtaining a current speech part at each interval in time.
   4. The method according to any of the preceding items, wherein the first model is a periodic model.
   5. The method according to any of the preceding items, wherein processing the first sound signal, which is based on the updated first model to obtain the first speech part, comprises filtering the first sound signal in a periodic filter.
   6. The method according to any of the preceding items, wherein filtering the first sound signal in the periodic filter comprises applying multiples of the estimated first fundamental frequency of the user's speech.
   7. The method according to any of the preceding items, wherein the periodic model is a harmonic model, and wherein the periodic filter is a harmonic filter.
   8. The method according to any of the preceding items, wherein the method further comprises:
processing the obtained first speech part; and wherein the processing of the obtained first speech part comprises mixing a noise signal with the obtained first speech part.
   9. The method according to any of the preceding items, wherein the internal input transducer is configured to be arranged in the ear canal of the user or on the body of the user.
   10. The method according to any of the preceding items, wherein the internal input transducer comprises a vibration sensor.
   11. The method according to any of the preceding items, wherein the bandwidth of the vibration sensor is configured to span low frequencies of the user's speech, the low frequencies being up to approximately 1.5 kHz.
   12. The method according to any of the preceding items, wherein the first external input transducer is a microphone configured to point towards the surroundings.
   13. The method according to any of the preceding items, wherein the electronic device further comprises a second external input transducer, and wherein processing the first sound signal, which is based on the updated first model to obtain the first speech part, comprises beamforming the first sound signal in a periodic beamformer.
   14. The method according to any of the preceding items, wherein the electronic device comprises a first hearing device and a second hearing device, and wherein the first fundamental frequency is configured to be estimated in the first hearing device and/or in the second hearing device.
   15. An electronic device for obtaining a user's speech in a first sound signal, the first sound signal comprising the user's speech and noise from the surroundings, the electronic device comprising:
a first external input transducer configured for capturing the first sound signal, the first sound signal comprising a first speech part of the user's speech and a first noise part;
an internal input transducer configured for capturing a second signal, the second signal comprising a second speech part of the user's speech;
   where the first speech part and the second speech part are of a same speech portion of the user's speech at a first interval in time;
a signal processor configured for:
estimating a fundamental frequency of the user's speech at the first interval in time, the fundamental frequency being estimated based on the second signal;
entering/applying the estimated fundamental frequency of the user's speech at the first interval in time into a first model to update the first model;
processing the first sound signal based on the updated first model to obtain the first speech part of the first sound signal.

### LIST OF REFERENCES

2 electronic device
4 first external input transducer
4′ second external input transducer
4″ third external input transducer
6 signal processor
8 output transducer
10 first sound signal comprising a first speech part of the user's speech and a first noise part
12 internal input transducer
14 second signal comprising a second speech part of the user's speech
16 transceiver
18 antenna
20 user's ear
22 user of the electronic device
24 far-end caller or recipient
26 user's speech
28 noise/sounds from the surrounding
30 wireless connection
32 transceiver of a second electronic device
100 method for obtaining a user's speech in a first sound signal
102 step of estimating a first fundamental frequency of the user's speech at the first interval in time
104 step of applying the estimated first fundamental frequency of the user's speech at the first interval in time into a first model to update the first model
106 step of processing the first sound signal based on the updated first model to obtain the first speech part of the first sound signal

1. A method performed by an electronic device, the method comprising:
capturing, by a first external input transducer of the electronic device, a first sound signal, the first sound signal comprising a first speech part of a speech of a user and a first noise part of noise from a surrounding;
capturing, by an internal input transducer of the electronic device, a second signal, the second signal comprising a second speech part of the speech of the user, where the first speech part and the second speech part are of a same speech portion of the speech at a first time interval;
estimating, by a signal processor of the electronic device, a first fundamental frequency of the speech of the user at the first time interval, the first fundamental frequency being estimated based on the second signal;
updating, by the signal processor, a first model based on the estimated first fundamental frequency of the speech of the user at the first time interval; and
processing, by the signal processor, the first sound signal based on the updated first model to obtain the first speech part of the first sound signal.

2. The method according to claim 1, further comprising:
capturing, by the first external input transducer, a third sound signal, the third sound signal comprising a third speech part of the speech of the user;
capturing, by the internal input transducer, a fourth signal, the fourth signal comprising a fourth speech part of the speech of the user, where the third speech part and the fourth speech part are of a same speech portion of the speech of the user at a second time interval;
estimating a second fundamental frequency of the speech of the user at the second time interval, the second fundamental frequency being estimated based on the fourth signal;
updating the first model based on the estimated second fundamental frequency of the speech of the user at the second time interval; and
processing the third sound signal to obtain the third speech part, wherein the act of processing the third sound signal is performed based on the first model that has been updated based on the estimated second fundamental frequency.

3. The method according to claim 1, further comprising:
estimating additional fundamental frequencies of the speech of the user at additional time intervals respectively;
updating the first model based on the estimated additional fundamental frequency at each of the additional time intervals; and
obtaining a speech part for each of the additional time intervals.

4. The method according to claim 1, wherein the first model is a periodic model.

5. The method according to claim 1, wherein the act of processing the first sound signal based on the updated first model to obtain the first speech part comprises filtering the first sound signal in a periodic filter.

6. The method according to claim 5, wherein act of filtering the first sound signal in the periodic filter comprises applying multiples of the estimated first fundamental frequency.

7. The method according to claim 5, wherein the first model is a harmonic model, and wherein the periodic filter is a harmonic filter.

8. The method according to claim 1, further comprising processing the obtained first speech part; wherein the act of processing the obtained first speech part comprises mixing a noise signal with the obtained first speech part.

9. The method according to claim 1, wherein the internal input transducer is configured to be arranged in an ear canal of the user or on a body of the user.

10. The method according to claim 1, wherein the internal input transducer comprises a vibration sensor.

11. The method according to claim 10, wherein a bandwidth of the vibration sensor is configured to span low frequencies of the speech of the user, the low frequencies being up to approximately 1.5 kHz.

12. The method according to claim 1, wherein the first external input transducer is a microphone configured to point towards the surrounding.

13. The method according to claim 1, wherein the electronic device further comprises a second external input transducer, and wherein the act of processing the first sound signal based on the updated first model to obtain the first speech part comprises beamforming the first sound signal in a periodic beamformer.

14. The method according to claim 1, wherein the electronic device comprises a first hearing device and a second hearing device, and wherein the first fundamental frequency is estimated by the first hearing device and/or the second hearing device.

15. An electronic device comprising:
a first external input transducer configured to capture a first sound signal, the first sound signal comprising a first speech part of a speech of a user and a first noise part of noise from a surrounding;
an internal input transducer configured to capture a second signal, the second signal comprising a second speech part of the speech of the user, where the first speech part and the second speech part are of a same speech portion of the speech at a first time interval; and
a signal processor configured to:
estimate a fundamental frequency of the speech of the user at the first time interval based on the second signal;
update the first model based on the estimated fundamental frequency of the speech at the first time interval; and
process the first sound signal based on the updated first model to obtain the first speech part.
